(19) United States
(12) Patent Application Publication
(10) Pub. No.: US 2020/0012724 A1
(43) Pub. Date: Jan. 9, 2020

(54) BIDIRECTIONAL SPEECH TRANSLATION SYSTEM, BIDIRECTIONAL SPEECH TRANSLATION METHOD AND PROGRAM

(71) Applicant: SOURCENEXT CORPORATION, Tokyo (JP)

(72) Inventor: Hajime KAWATAKE, Chuo-ku, Tokyo, Japan (JP)

(21) Appl. No.: 15/780,628

(22) PCT Filed: Dec. 6, 2017
(86) PCT No.: PCT/JP2017/043792

§ 371 Date: May 31, 2018

(51) Int. Cl. G06F 17/28; G10L 13/04; G10L 15/00; G10L 13/033; G10L 15/22

(52) U.S. Cl. CPC G06F 17/289; G10L 13/043; G10L 15/22; G10L 13/033; G10L 15/005

(57) ABSTRACT

A bidirectional speech translation system, a bidirectional speech translation, method and a program are provided for executing speech translation by using a combination of a speech recognition engine, a translation engine, and a speech synthesis engine that are suitable for received speech or a language of the received speech. The bidirectional speech translation system executes processing for synthesizing speech by translating first language speech entered by a first speaker into a second language and processing for synthesizing speech by translating second language speech entered by a second speaker into a first language. The engine determining unit determines a combination of a first speech recognition engine, a first translation engine, and a first speech synthesis engine, and a combination of a second speech recognition engine, a second translation engine, and a second speech synthesis engine based on at least one of the first language, the first language speech entered by the first speaker, the second language, and the second language speech entered by the second speaker.

### TECHNICAL FIELD

This disclosure relates to a bidirectional speech translation system, a bidirectional speech translation method, and a program.

### BACKGROUND ART

Patent Literature 1 describes a translator having enhanced operability by one hand. The translator described in Patent Literature 1 stores a translation program and translation data including an input acoustic model, a language model, and an output acoustic model in a memory included in a translation unit provided on a case body.

In the translator described in Patent Literature 1, the processing unit included in the translation unit converts speech in the first language received through a microphone into textual information of the first language using the input acoustic model and the language model. The processing unit translates or converts the textual information of the first language into textual information of the second language using the translation model and the language model. The processing unit converts the textual information of the second language into speech using the output acoustic model, and outputs the speech in the second language through a speaker.

The translator described in Patent Literature 1 determines a combination of a first language and a second language in advance for each translator.

### CITATION LIST

### Patent Literature

Patent Literature 1: JP2017-151619A

### SUMMARY OF INVENTION

### Technical Problem

In two-way conversations between the first speaker speaking the first language and the second speaker speaking the second language, however, the translator described in Patent Literature 1 cannot alternately perform translation of the speech of the first speaker into the second language and translation of the speech of the second speaker into the first language in a smooth manner.

The translator described in Patent Literature 1 translates any received speech using given translation data that is stored. As such, for example, even if there is a speech recognition engine or a translation engine more suitable for a pre-translation language or a post-translation language, it is not possible to perform speech recognition or translation using such an engine. Further, for example, even if there is a translation engine or a speech synthesis engine suitable for reproducing the speaker's attributes, such as age and gender, it is not possible to perform translation or speech synthesis using such an engine.

The present disclosure has been made in view of the aforementioned circumstances, and it is an objective of the present disclosure to provide a bidirectional speech translation system, a bidirectional speech translation method, and a program for executing speech translation by using a combination of a speech recognition engine, a translation engine, and a speech synthesis engine that are suitable for received speech or a language of the speech.

### Solution to Problem

In order to solve the above described problems, a bidirectional speech translation system according to this disclosure executes processing for synthesizing, in response to an entry of first language speech by a first speaker, speech by translating the first language speech into a second language, and processing for synthesizing, in response to an entry of second language speech by a second speaker, speech by translating the second language speech into the first language. The bidirectional speech translation system includes a first determining unit that determines a combination of a first speech recognition engine, a first translation engine, and a first speech synthesis engine, based on at least one of the first language, the first language speech entered by the first speaker, the second language, and the second language speech entered by the second speaker, the first speech recognition engine being one of a plurality of speech recognition engines, the first translation engine being one of a plurality of translation engines, the first speech synthesis engine being one of a plurality of speech synthesis engines, a first speech recognition unit that executes speech recognition processing implemented by the first speech recognition engine, in response to the entry of the first language speech by the first speaker, to generate text that is a recognition result of the first language speech, a first translation unit that executes translation processing implemented by the first translation engine to generate text by translating the text generated by the first speech recognition unit into the second language, a first speech synthesizing unit that executes speech synthesizing processing implemented by the first speech synthesis engine to synthesize speech representing the text translated by the first translation unit, a second determining unit that determines a combination of a second speech recognition engine, a second translation engine, and a second speech synthesis engine based on at least one of the first language, the first language speech entered by the first speaker, the second language, and the second language speech entered by the second speaker, the second speech recognition engine being one of the plurality of speech recognition engines, the second translation engine being one of the plurality of translation engines, the second speech synthesis engine being one of the plurality of speech synthesis engines, a second speech recognition unit that executes speech recognition processing implemented by the second speech recognition engine, in response to the entry of the second language speech by the second speaker, to generate text that is a recognition result of the second language speech, a second translation unit that executes translation processing implemented by the second translation engine to generate text by translating the text generated by the second speech recognition unit into the first language, and a second speech synthesizing unit that executes speech synthesizing processing implemented by the second speech synthesis engine to synthesize speech representing the text translated by the second translation unit.

In an aspect of this disclosure, the first speech synthesizing unit synthesizes speech in accordance with at least one of age, generation, and gender of the first speaker estimated based on a feature amount of speech entered by the first speaker.

In an aspect of this disclosure, the first speech synthesizing unit synthesizes speech in accordance with emotion of the first speaker estimated based on a feature amount of speech entered by the first speaker.

In an aspect of this disclosure, the second speech synthesizing unit synthesizes speech in accordance with at least one of age, generation, and gender of the first speaker estimated based on a feature amount of speech entered by the first speaker.

In an aspect of this disclosure, the second translation unit determines a plurality of translation candidates for a translation target word included in the text generated by the second speech recognition unit, checks the plurality of translation candidates to see whether each of the translation candidates is included in the text generated by the first translation unit, and translates the translation target word into a word that is determined to be included in the text generated by the first translation unit.

In an aspect of this disclosure, the first speech synthesizing unit synthesizes speech having a speed in accordance with an entry speed of the first language speech by the first speaker or speech having volume in accordance with volume of the first language speech by the first speaker.

In an aspect of this disclosure, the second speech synthesizing unit synthesizes speech having a speed in accordance with an entry speed of the first language speech by the first speaker or speech having volume in accordance with volume of the first language speech by the first speaker.

In an aspect of this disclosure, the bidirectional speech translation system includes a terminal that receives an entry of first language speech by the first speaker, outputs speech obtained by translating the first language speech into the second language, receives an entry of second language speech by the second speaker, and outputs speech obtained by translating the second language speech into the first language. The first determining unit determines the combination of the first speech recognition engine, the first translation engine, and the first speech synthesis engine based on a location of the terminal. The second determining unit determines the combination of the second speech recognition engine, the second translation engine, and the second speech synthesis engine based on a location of the terminal.

A bidirectional speech translation method according to this disclosure executes processing for synthesizing, in response to an entry of first language speech by a first speaker, speech by translating the first language speech into a second language, and processing for synthesizing, in response to an entry of second language speech by a second speaker, speech by translating the second language speech into the first language. The bidirectional speech translation method includes a first determining step of determining a combination of a first speech recognition engine, a first translation engine, and a first speech synthesis engine, based on at least one of the first language, the first language speech entered by the first speaker, the second language, and the second language speech entered by the second speaker, the first speech recognition engine being one of a plurality of speech recognition engines, the first translation engine being one of a plurality of translation engines, the first speech synthesis engine being one of a plurality of speech synthesis engines, a first speech recognition step of executing speech recognition processing implemented by the first speech recognition engine, in response to the entry of first language speech by the first speaker, to generate text that is a recognition result of the first language speech, a first translation step of executing translation processing implemented by the first translation engine to generate text by translating the text generated in the first speech recognition step into the second language, a first speech synthesizing step of executing speech synthesizing processing implemented by the first speech synthesis engine to synthesize speech representing the text translated in the first translation step, a second determining step of determining a combination of a second speech recognition engine, a second translation engine, and a second speech synthesis engine based on at least one of the first language, the first language speech entered by the first speaker, the second language, and the second language speech entered by the second speaker, the second speech recognition engine being one of the plurality of speech recognition engines, the second translation engine being one of the plurality of translation engines, the second speech synthesis engine being one of the plurality of speech synthesis engines, a second speech recognition step of executing speech recognition processing implemented by the second speech recognition engine, in response to the entry of the second language speech by the second speaker, to generate text that is a recognition result of the second language speech, a second translation step of executing translation processing implemented by the second translation engine to generate text by translating the text generated in the second speech recognition step into the first language, and a second speech synthesizing step of executing speech synthesizing processing implemented by the second speech synthesis engine to synthesize speech representing the text translated in the second translation step.

A program according to this disclosure causes a computer to execute processing for synthesizing, in response to an entry of first language speech by a first speaker, speech by translating the first language speech into a second language, and processing for synthesizing, in response to an entry of second language speech by a second speaker, speech by translating the second language speech into the first language. The program causes the computer to execute a first determining process of determining a combination of a first speech recognition engine, a first translation engine, and a first speech synthesis engine, based on at least one of the first language, the first language speech entered by the first speaker, the second language, and the second language speech entered by the second speaker, the first speech recognition engine being one of a plurality of speech recognition engines, the first translation engine being one of a plurality of translation engines, the first speech synthesis engine being one of a plurality of speech synthesis engines, a first speech recognition process of executing speech recognition processing implemented by the first speech recognition engine, in response to the entry of first language speech by the first speaker, to generate text that is a recognition result of the first language speech, a first translation process of executing translation processing implemented by the first translation engine to generate text by translating the text generated in the first speech recognition process into the second language, a first speech synthesizing process of executing speech synthesizing processing implemented by the first speech synthesis engine to synthesize speech representing the text translated in the first translation process, a second determining process of determining a combination of a second speech recognition engine, a second translation engine, and a second speech synthesis engine based on at least one of the first language, the first language speech entered by the first speaker, the second language, and the second language speech entered by the second speaker, the second speech recognition engine being one of the plurality of speech recognition engines, the second translation engine being one of the plurality of translation engines, the second speech synthesis engine being one of the plurality of speech synthesis engines, a second speech recognition process of executing speech recognition processing implemented by the second speech recognition engine, in response to the entry of the second language speech by the second speaker, to generate text that is a recognition result of the second language speech, a second translation process of executing translation processing implemented by the second translation engine to generate text by translating the text generated in the second speech recognition process into the first language, and a second speech synthesizing process of executing speech synthesizing processing implemented by the second speech synthesis engine to synthesize speech representing the text translated in the second translation process.

### BRIEF DESCRIPTION OF DRAWINGS

FIG. 1 is a diagram illustrating an example of an overall configuration of a translation system according to an embodiment of this disclosure;

FIG. 2 is a diagram illustrating an example of a configuration of a translation terminal according to an embodiment of this disclosure;

FIG. 3 is a functional block diagram showing an example of functions implemented in a server according to an embodiment of this disclosure;

FIG. 4A is a diagram illustrating an example of analysis target data;

FIG. 4B is a diagram illustrating an example of analysis target data;

FIG. 5A is a diagram illustrating an example of log data;

FIG. 5B is a diagram illustrating an example of log data;

FIG. 6 is a diagram illustrating an example of language engine correspondence management data;

FIG. 7 is a diagram illustrating an example of attribute engine correspondence management data; and

FIG. 8 is a flow chart showing an example of processing executed in the server according to an embodiment of this disclosure.

### DESCRIPTION OF EMBODIMENTS

An embodiment of the present disclosure will be described below with reference to the accompanying drawings.

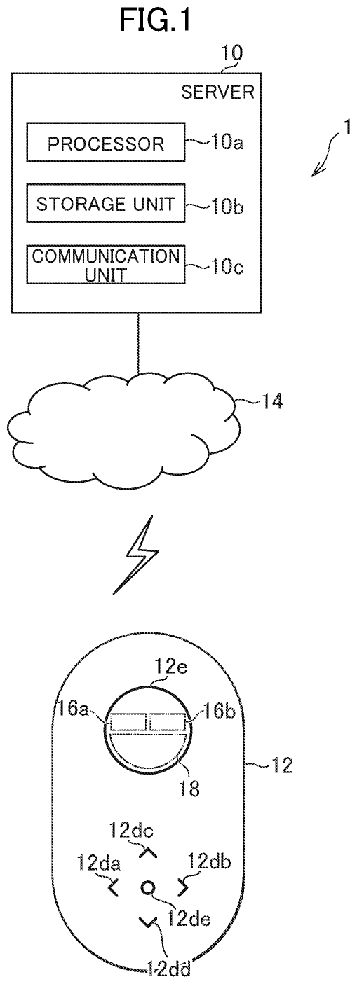

FIG. 1 illustrates an example of an overall configuration of a translation system 1, which is an example of a bidirectional speech translation system proposed in this disclosure. As shown in FIG. 1, the translation system 1 proposed in this disclosure includes a server 10 and a translation terminal 12. The server 10 and the translation terminal 12 are connected to a computer network 14, such as the Internet. The server 10 and the translation terminal 12 thus can communicate with each other via the computer network 14, such as the Internet.

As shown in FIG. 1, the server 10 according to this embodiment includes, for example, a processor 10a, a storage unit 10b, and a communication unit 10c.

The processor 10a is a program control device, such as a microprocessor that operates according to a program installed in the server 10. The storage unit 10b is, for example, a storage element such as a ROM and a RAM, or a hard disk drive. The storage unit 10b stores a program that is executed by the processor 10a, for example. The communication unit 10c is a communication interface, such as a network board, for transmitting/receiving data to/from the translation terminal 12 via the computer network 14, for example. The server 10 transmits/receives data to/from the translation terminal 12 via the communication unit 10c.

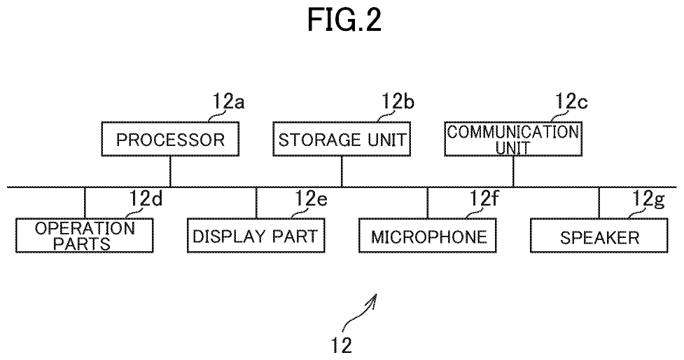

FIG. 2 illustrates an example of the configuration of the translation terminal 12 shown in FIG. 1. As shown in FIG. 2, the translation terminal 12 according to this embodiment includes, for example, a processor 12a, a storage unit 12b, a communication unit 12c, operation parts 12d, a display part 12e, a microphone 12f, and a speaker 12g.

The processor 12a is, for example, a program control device, such as a microprocessor that operates according to a program installed in the translation terminal 12. The storage unit 12b is a storage element, such as a ROM and a RAM. The storage unit 12b stores a program that is executed by the processor 12a.

The communication unit 12c is a communication interface for transmitting/receiving data to/from the server 10 via the computer network 14, for example. The communication unit 12c may include a wireless communication module, such as a 3G module, for communicating with the computer network 14, such as the Internet, through a mobile telephone line including a base station. The communication unit 12c may include a wireless LAN module for communicating with the computer network 14, such as the Internet, via a Wi-Fi (registered trademark) router, for example.

The operation parts 12d are operating members that output an operation of a user to the processor 12a, for example. As shown in FIG. 1, the translation terminal 12 according to this embodiment includes five operation parts 12d (12da, 12db, 12dc, 12dd, 12de) on the lower front side thereof. The operation part 12da, the operation part 12db, the operation part 12dc, the operation part 12dd, and the operation part 12de are respectively and relatively disposed on the left, the right, the upper, the lower, and the center of the lower front part of the translation terminal 12. The operation part 12d is described herein as a touch sensor, although the operation part 12d may be an operating member other than the touch sensor, such as a button.

The display part 12e includes a display, such as a liquid crystal display and an organic EL display, and displays an image generated by the processor 12a, for example. As shown in FIG. 1, the translation terminal 12 according to this embodiment has a circular display part 12e on the upper front side thereof.

The microphone 12f is speech input device that converts the received speech into an electric signal, for example. The microphone 12f may be dual microphones with a noise canceling function, which are embedded in the translation terminal 12 and facilitate recognition of human voice even in crowds.

The speaker 12g is an audio output device that outputs speech, for example. The speaker 12g may be a dynamic speaker that is embedded in the translation terminal 12 and can be used in a noisy environment.

The translation system 1 according to this embodiment can alternately translate the first speaker's speech and the second speaker's speech in two-way conversations between the first speaker and the second speaker.

In the translation terminal 12 according to this embodiment, a predetermined operation is performed on the unit 12d to set languages so that the language of the first speaker's speech and the language of the second speaker's speech are determined among from, for example, fifty given languages. In the following, the speech of the first speaker is referred to as a first language, and the speech of the second speaker is referred to as a second language. In this embodiment, a first language display area 16a in the upper left of the display part 12e displays an image indicating the first language, such as an image of a national flag of a country in which the first language is used, for example. Further, in this embodiment, a second language display area 16b in the upper right of the display part 12e displays a national flag of a country in which the second language is used, for example.

For example, assume that the first speaker performs a speech entry operation in which the first speaker enters speech in the first language in the translation terminal 12. The speech entry operation of the first speaker may be a series of operations including tapping the operation part 12da by the first speaker, entering speech in the first language while the operation part 12da being tapped, and releasing the tap state of the operation part 12da, for example.

Subsequently, a text display area 18 disposed below the display part 12e displays a text, which is a result of the speech recognition of the speech entered by the first speaker. The text according to this embodiment is a character string indicating one or more clauses, phrases, words, or sentences. After that, the text display area 18 displays a text obtained by translating the displayed text into the second language, and the speaker 12g outputs speech indicating the translated text, that is, speech obtained by translating the speech in the first language entered by the first speaker into the second language.

Subsequently, for example, assume that the second speaker performs a speech entry operation in which the second speaker enters speech in the second language in the translation terminal 12. The speech entry operation by the second speaker may be a series of operations including tapping the operation part 12db by the second speaker, entering speech in the second language while the operation part 12db being tapped, and releasing the tap state of the operation part 12db, for example.

Subsequently, a text display area 18 disposed below the display part 12e displays a text, which is a result of the speech recognition of the speech entered by the second speaker. After that, the text display area 18 displays a text obtained by translating the displayed text into the first language, and the speaker 12g outputs speech indicating the translated text, that is, speech obtained by translating the speech in the second language entered by the second speaker into the first language. Subsequently, in the translation system. 1 according to this embodiment, every time a speech entry operation by the first speaker and a speech entry operation by the second speaker are performed alternately, speech obtained by translating the entered speech into the other language is output.

In the following, functions and processing executed in the server 10 according to this embodiment will be described.

The server 10 according to this embodiment executes processing for, in response to entry of speech in the first language by the first speaker, synthesizing speech by translating the entered speech into the second language, and the processing for, in response to entry of speech in the second language by the second speaker, synthesizing speech by translating the entered speech into the first language.

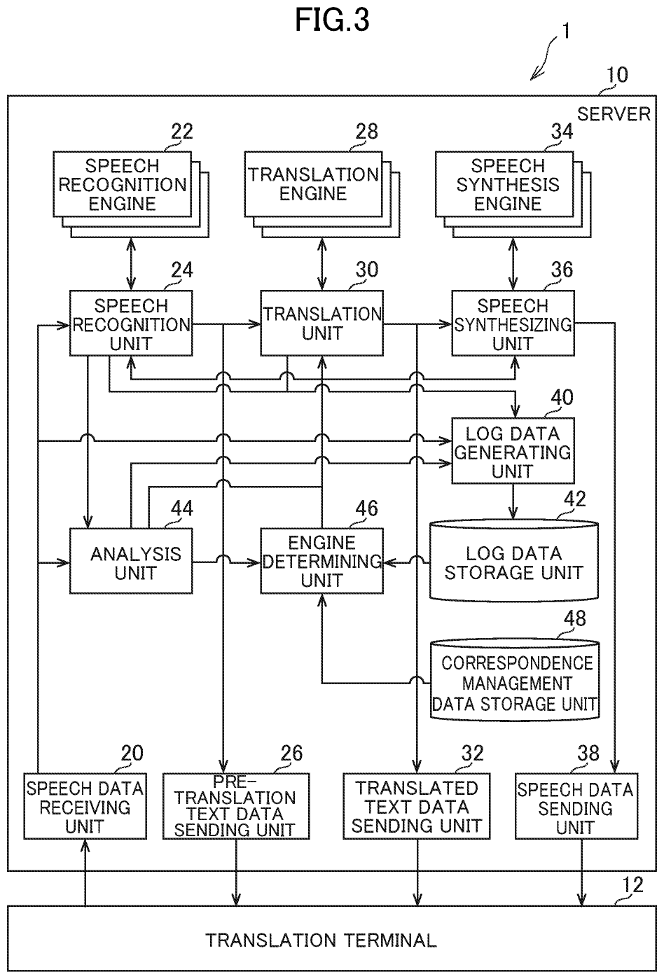

FIG. 3 is a functional block diagram showing an example of functions implemented in the server 10 according to this embodiment. The server 10 according to this embodiment should not necessarily implement all of the functions shown in FIG. 3, and may implement a function other than the functions shown in FIG. 3.

As shown in FIG. 3, the server 10 according to this embodiment functionally includes, for example, a speech data receiving unit 20, a plurality of speech recognition engines 22, a speech recognition unit 24, a pre-translation text data sending unit 26, a plurality of translation engines 28, a translation unit 30, a translated text data sending unit 32, a plurality of speech synthesis engines 34, a speech synthesizing unit 36, a speech data sending unit 38, a log data generating unit 40, a log data storage unit 42, an analysis unit 44, an engine determining unit 46, and a correspondence management data storage unit 48.

The speech recognition engines 22, the translation engines 28, and the speech synthesis engines 34 are implemented mainly by the processor 10a and the storage unit 10b. The speech data receiving unit 20, the pre-translation text data sending unit 26, the translated text data sending unit 32, and the speech data sending unit 38 are implemented mainly by the communication unit 10c. The speech recognition unit 24, the translation unit 30, the speech synthesizing unit 36, the log data generating unit 40, the analysis unit 44, and the engine determining unit 46 are implemented mainly by the processor 10a. The log data storage unit 42 and the correspondence management data storage unit 48 are implemented mainly by the storage unit 10b.

The functions described above are implemented when the processor 10a executes a program that is installed in the server 10, which is a computer, and contains commands corresponding to the functions. This program is provided to the server 10 via the Internet or a computer-readable information storage medium, such as an optical disc, a magnetic disk, a magnetic tape, a magneto-optical disk, and a flash memory.

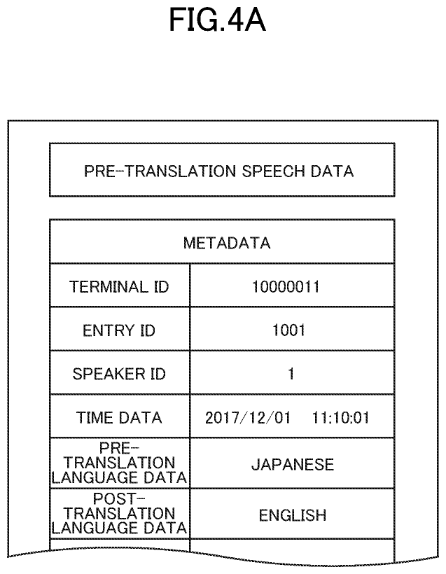

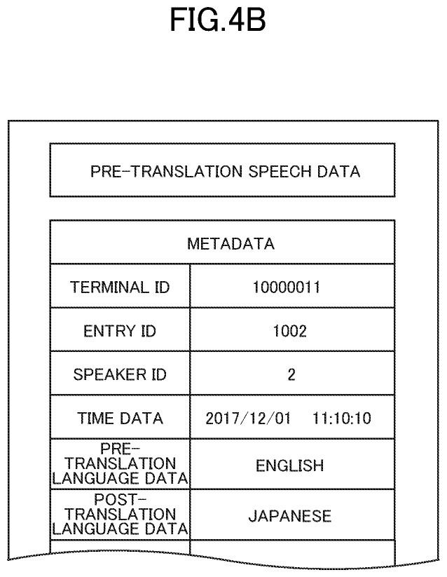

In the translation system 1 according to this embodiment, when the speech entry operation is performed by the speaker, the translation terminal 12 generates analysis target data illustrated in FIGS. 4A and 4B. The translation terminal 12 then sends the generated analysis target data to the server 10. FIG. 4A illustrates an example of analysis target data generated when the first speaker performs the speech entry operation. FIG. 4B illustrates an example of analysis target data generated when the second speaker performs the speech entry operation. FIGS. 4A and 4B illustrate examples of analysis target data when the first language is Japanese and the second language is English.

As shown in FIGS. 4A and 4B, the analysis target data includes pre-translation speech data and metadata.

The pre-translation speech data is speech data indicating a speaker's speech entered through the microphone 12f, for example. Here, the pre-translation speech data may be speech data generated by coding and quantizing the speech entered through the microphone 12f, for example.

The metadata includes a terminal ID, an entry ID, a speaker ID, time data, pre-translation language data, and post-translation language data, for example.

The terminal ID is identification information of a translation terminal 12, for example. In this embodiment, for example, each translation terminal 12 provided to a user is assigned with a unique terminal ID.

The entry ID is identification information of speech entered by a single speech entry operation, for example. In this embodiment, the entry ID is identification information of the analysis target data, for example. In this embodiment, values of entry IDs are assigned according to the order of the speech entry operations performed in the translation terminal 12.

The speaker ID is identification information of a speaker, for example. In this embodiment, for example, when the first speaker performs a speech entry operation, 1 is set as the value of the speaker ID, and when the second speaker performs speech entry operation, 2 is set as the value of the speaker ID.

The time data indicates a time at which a speech entry operation is performed, for example.

The pre-translation language data indicates a language of speech entered by a speaker, for example. In the following, a language of speech entered by a speaker is referred to as a pre-translation language. For example, when the first speaker performs a speech entry operation, a value indicating the language set as the first language is set as a value of the pre-translation language data. For example, when the second speaker performs a speech entry operation, a value indicating the language set as the second language is set as a value of the pre-translation language data.

The post-translation language data indicates, for example, a language set as a language of speech that is caught by a conversation partner, that is, a listener of a speaker who performs the speech entry operation. In the following, a language of speech to be caught by a listener is referred to as a post-translation language. For example, when the first speaker performs a speech entry operation, a value indicating the language set as the second language is set as a value of the post-translation language data. For example, when the second speaker performs a speech entry operation, a value indicating the language set as the first language is set as a value of the post-translation language data.

In this embodiment, the speech data receiving unit 20 receives, for example, speech data indicating speech entered in a translation terminal 12. Here, the speech data receiving unit 20 may receive analysis target data that includes speech data, which indicates speech entered in the translation terminal 12 as described above, as pre-translation speech data.

In this embodiment, each of the speech recognition engines 22 is a program in which, for example, speech recognition processing for generating text that is a recognition result of speech is implemented. The speech recognition engines 22 have different specifications, such as recognizable languages. In this embodiment, for example, each of the speech recognition engines 22 is previously assigned with a speech recognition engine ID, which is identification information of corresponding speech recognition engine 22.

In this embodiment, for example, in response to entry of speech by a speaker, the speech recognition unit 24 generates text, which is a recognition result of the speech. The speech recognition unit 24 may generate text that is a recognition result of speech indicated by the speech data received by the speech data receiving unit 20.

The speech recognition unit 24 may execute speech recognition processing, which is implemented by a speech recognition engine 22 determined by the engine determining unit 46 as described later, so as to generate text that is a recognition result of the speech. For example, the speech recognition unit 24 may call a speech recognition engine 22 determined by the engine determining unit 46, cause the speech recognition engine 22 to execute the speech recognition processing, and receive text, which is a result of the speech recognition processing, from the speech recognition engine 22.

In the following, a speech recognition engine 22 determined by the engine determining unit 46 in response to a speech entry operation by the first speaker is referred to as a first speech recognition engine 22. Further, a speech recognition engine 22 determined by the engine determining unit 46 in response to a speech entry operation by the second speaker is referred to as a second speech recognition engine 22.

In this embodiment, for example, the pre-translation text data sending unit 26 sends pre-translation text data, which indicates text generated by the speech recognition unit 24, to a translation terminal 12. Upon receiving the text indicated by the receiving pre-translation text data from the pre-translation text data sending unit 26, the translation terminal 12 displays the text on the text display area 18 as described above, for example.

In this embodiment, for example, each of the translation engines 28 is a program in which translation processing for translating text is implemented. The translation engines 28 have different specifications, such as translatable languages and dictionaries used for translation. In this embodiment, for example, each of the translation engines 28 is previously assigned with a translation engine ID, which is identification information of corresponding translation engine 28.

In this embodiment, for example, the translation unit 30 generates text by translating text generated by the speech recognition unit 24. The translation unit 30 may execute the translation processing implemented by a translation engine 28 determined by the engine determining unit 46 as described later, and generate text by translating the text generated by the speech recognition unit 24. For example, the translation unit 30 may call a translation engine 28 determined by the engine determining unit 46, cause the translation engine 28 to execute the translation processing, and receive text that is a result of the translation processing from the translation engine 28.

In the following, a translation engine 28 determined by the engine determining unit 46 in response to a speech entry operation by the first speaker is referred to as a first translation engine 28. Further, a translation engine 28 determined by the engine determining unit 46 in response to a speech entry operation by the second speaker is referred to as a second translation engine 28.

In this embodiment, for example, the translated text data sending unit 32 sends translated text data, which indicates text translated by the translation unit 30, to a translation terminal 12. Upon receiving the text indicated by the translated text data from the translated text data sending unit 32, the translation terminal 12 displays the text on the text display area 18 as described above, for example.

In this embodiment, for example, each of the speech synthesis engines 34 is a program in which speech synthesizing processing for synthesizing speech representing text is implemented. The speech synthesis engines 34 have different specifications, such as tones or types of speech to be synthesized. In this embodiment, for example, each of the speech synthesis engines 34 is previously assigned with a speech synthesis engine ID, which is identification information for corresponding speech synthesis engine 34.

In this embodiment, for example, the speech synthesizing unit 36 synthesizes speech representing text translated by the translation unit 30. The speech synthesizing unit 36 may generate translated speech data, which is speech data obtained by synthesizing speech representing the text translated by the translation unit 30. The speech synthesizing unit 36 may execute speech synthesizing processing implemented by a speech synthesis engine 34 determined by the engine determining unit 46 as described later, and synthesizes speech representing the text translated by the translation unit 30. For example, the speech synthesizing unit 36 may call a speech synthesis engine 34 determined by the engine determining unit 46, cause the speech synthesis engine 34 to execute speech synthesizing processing, and receive speech data, which is a result of the speech synthesizing processing, from the speech synthesis engine 34.

In the following, a speech synthesis engine 34 determined by the engine determining unit 46 in response to a speech entry operation by the first speaker is referred to as a first speech synthesis engine 34. Further, a speech synthesis engine 34 determined by the engine determining unit 46 in response to a speech entry operation by the second speaker is referred to as a second speech synthesis engine 34.

In this embodiment, for example, the speech data sending unit 38 sends speech data, which indicates speech synthesized by the speech synthesizing unit 36, to a translation terminal 12. Upon receiving the translated speech data from the speech data sending unit 38, the translation terminal 12 outputs, for example, speech indicated by the translated speech data to the speaker 12g as described above.

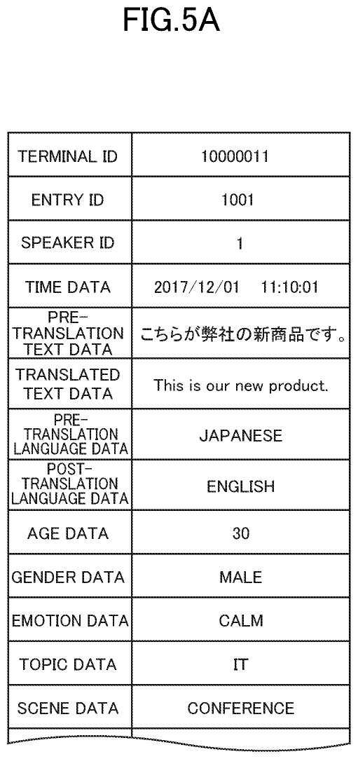

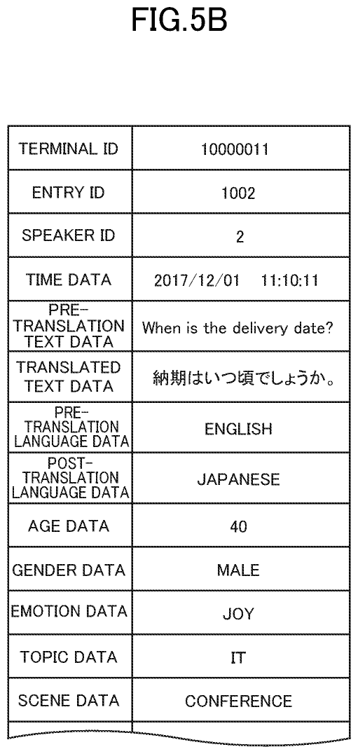

In this embodiment, for example, the log data generating unit 40 generates log data indicating logs about translation of speech of speakers as illustrated in FIGS. 5A and 5B, and stores the log data in the log data storage unit 42.

FIG. 5A shows an example of log data generated in response to a speech entry operation by the first speaker. FIG. 5B shows an example of log data generated in response to a speech entry operation by the second speaker.

The log data includes, for example, a terminal ID, an entry ID, a speaker ID, time data, pre-translation text data, translated text data, pre-translation language data, post-translation language data, age data, gender data, emotion data, topic data, and scene data.

For example, values of a terminal ID, an entry ID, and a speaker ID of metadata included in analysis target data received by the speech data receiving unit 20 may be respectively set as values of a terminal ID, an entry ID and a speaker ID of log data to be generated. For example, a value of the time data of the metadata included in the analysis target data received by the speech data receiving unit 20 may be set as a value of time data of log data to be generated. For example, values of the pre-translation language data and the post-translation language data of the metadata included in the analysis target data received by the speech data receiving unit 20 may be set as values of pre-translation language data and post-translation language data included in log data to be generated.

For example, a value of age or generation of a speaker who performs the speech entry operation may be set as a value of age data included in log data to be generated. For example, a value indicating gender of a speaker who performs the speech entry operation may be set as a value of gender data included in log data to be generated. For example, a value indicating emotion of a speaker who performs the speech entry operation may be set as a value of emotion data included in log data to be generated. For example, a value indicating a topic (genre) of a conversation, such as medicine, military, IT, and travel, when the speech entry operation is performed may be set as a value of topic data included in log data to be generated. For example, values indicating a scene of a conversation, such as conference, business talk, chat, and speech, when the speech entry operation is performed may be set as a value of scene data included in log data to be generated.

As discussed later, the analysis unit 44 may perform analysis processing on speech data received by the speech data receiving unit 20. Then, values corresponding to results of the analysis processing may be set as values of age data, gender data, emotion data, topic data, and scene data included in log data to be generated.

For example, text indicating results of speech recognition by the speech recognition unit 24 of speech data received by the speech data receiving unit 20 may be set as values of pre-translation text data included in log data to be generated. For example, text indicating results of translation of the text by the translation unit 30 may be set as values of translated text data included in log data to be generated.

Although not shown in FIGS. 5A and 5B, the log data may additionally include data, such as entry speed data indicating entry speed of speech of the speaker who performs the speech entry operation, volume data indicating volume of the speech, and voice type data indicating a tone or a type of the speech.

In this embodiment, for example, the log data storage unit 42 stores log data generated by the log data generating unit 40. In the following, log data that is stored in the log data storage unit 42 and includes a terminal ID having a value the same as a value of a terminal ID of metadata included in analysis target data received by the speech data receiving unit 20 will be referred to as terminal log data.

The maximum number of records of the terminal log data stored in the log data storage unit 42 may be determined in advance. For example, up to 20 records of terminal log data may be stored in the log data storage unit 42 for a certain terminal ID. In a case where the maximum number of records of terminal log data are stored in the log data storage unit 42 as described above, when storing a new record of terminal log data in the log data storage unit 42, the log data generating unit 40 may delete the record of terminal log data including the time data indicating the oldest time.

In this embodiment, for example, the analysis unit 44 executes the analysis processing on speech data received by the speech data receiving unit 20 and on text that is a result of translation by the translation unit 30.

The analysis unit 44 may generate data of a feature amount of speech indicated by speech data received by the speech data receiving unit 20, for example. The data of the feature amount may include, for example, data based on a spectral envelope, data based on a linear prediction analysis, data about a vocal tract, such as a cepstrum, data about sound source, such as fundamental frequency and voiced/unvoiced determination information, and spectrogram.

In this embodiment, for example, the analysis unit 44 may execute analysis processing, such as known voiceprint analysis processing, thereby estimating attributes of a speaker who performs a speech entry operation, such as the speaker's age, generation, and gender. For example, attributes of a speaker who performs the speech entry operation may be estimated based on data of a feature amount of speech indicated by speech data received by the speech data receiving unit 20.

The analysis unit 44 may estimate attributes of a speaker who performs the speech entry operation, such as age, generation, and gender, based on text that is a result of translation by the translation unit 30, for example. For example, using known text analysis processing, attributes of a speaker who performs the speech entry operation may be estimated based on words included in text that is a result of translation. Here, as described above, the log data generating unit 40 may set a value indicating the estimated age or generation of the speaker as a value of age data included in log data to be generated. Further, as described above, the log data generating unit 40 may set a value of the estimated gender of the speaker as a value of gender data included in log data to be generated.

In this embodiment, for example, the analysis unit 44 executes analysis processing, such as known speech emotion analysis processing, thereby estimating emotion of a speaker who performs the speech entry operation, such as anger, joy, and calm. For example, emotion of a speaker who enters speech may be estimated based on data of a feature amount of the speech indicated by speech data received by the speech data receiving unit 20. As described above, the log data generating unit 40 may set a value indicating estimated emotion of the speaker as a value of emotion data included in log data to be generated.

The analysis unit 44 may specify, for example, entry speed and volume of speech indicated by speech data received by the speech data receiving unit 20. Further, the analysis unit 44 may specify, for example, voice tone or type of speech indicated by speech data received by the speech data receiving unit 20. The log data generating unit 40 may set values indicating the estimated speech entry speed, volume, and voice tone or type of speech as respective values of entry speed data, volume data, and voice type data included in log data to be generated.

The analysis unit 44 may estimate, for example, a topic or a scene of conversation when the speech entry operation is performed. Here, the analysis unit 44 may estimate a topic or a scene based on, for example, a text or words included in the text generated by the speech recognition unit 24.

When estimating the topic and the scene, the analysis unit 44 may estimate them based on the terminal log data. For example, the topic and the scene may be estimated based on text indicated by pre-translation text data included in the terminal log data or words included in the text, or text indicated by translated text data or words included in the text. The topic and the scene may be estimated based on text generated by the speech recognition unit 24 and the terminal log data. Here, the log data generating unit 40 may set values indicating the estimated topic and scene as values of topic data and scene data included in log data to be generated.

In this embodiment, for example, the engine determining unit 46 determines a combination of a speech recognition engine 22 for executing speech recognition processing, a translation engine 28 for executing translation processing, and a speech synthesis engine 34 for executing speech synthesizing processing. As described above, the engine determining unit 46 may determine a combination of a first speech recognition engine 22, a first translation engine 28, and a first speech synthesis engine 34 in accordance with a speech entry operation by the first speaker. The engine determining unit 46 may determine a combination of a second speech recognition engine 22, a second translation engine 28, and a second speech synthesis engine 34 in accordance with a speech entry operation by the second speaker. For example, the combination may be determined based on at least one of the first language, speech entered by the first speaker, the second language, and speech entered by the second speaker.

As described above, the speech recognition unit 24 may execute the speech recognition processing implemented by the first speech recognition engine 22, in response to an entry of speech in the first language by the first speaker, to generate text in the first language, which is a result of recognition of the speech. The translation unit 30 may execute the translation processing implemented by the first translation engine 28 to generate text by translating the text in the first language, which is generated by the speech recognition unit 24, in the second language. The speech synthesizing unit 36 may execute the speech synthesizing processing implemented by the first speech synthesis engine 34, to synthesize speech representing the text translated in the second language by the translation unit 30.

The speech recognition unit 24 may execute the speech recognition processing implemented by the second speech recognition engine 22, in response to an entry of speech in the second language by the second speaker, to generate text, which is a result of recognition of the speech in the second language. The translation unit 30 may execute the translation processing implemented by the second translation engine 28, to generate text by translating the text in the second language, which is generated by the speech recognition unit 24, in the first language. The speech synthesizing unit 36 may execute the speech synthesizing processing implemented by the first speech synthesis engine 34, to synthesize speech representing the text translated in the first language by the translation unit 30.

For example, when the first speaker enters speech, the engine determining unit 46 may determine a combination of a first speech recognition engine 22, a first translation engine 28, and a first speech synthesis engine 34 based on a combination of the pre-translation language and the post-translation language.

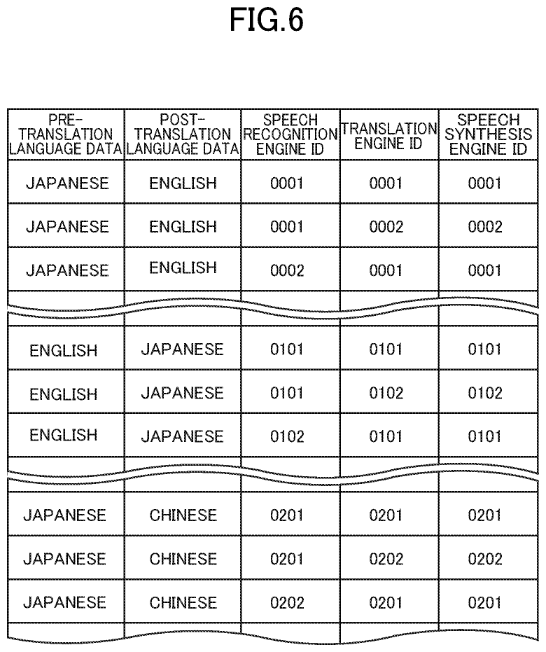

Here, for example, when the first speaker enters speech, the engine determining unit 46 may determine a combination of a first speech recognition engine 22, a first translation engine 28, and a first speech synthesis engine 34 based on language engine correspondence management data shown in FIG. 6.

As shown in FIG. 6, the language engine correspondence management data includes pre-translation language data, post-translation language data, a speech recognition engine ID, a translation engine ID, and a speech synthesis engine ID. FIG. 6 illustrates a plurality of records of language engine correspondence management data. A combination of a speech recognition engine 22, a translation engine 28, and a speech synthesis engine 34 suitable for a combination of a pre-translation language and a post-translation language may be set previously in the language engine correspondence management data, for example. The language engine correspondence management data may be previously stored in a correspondence management data storage unit 48.

Here, in advance, for example, a speech recognition engine ID of a speech recognition engine 22 capable of speech recognition processing for speech in the language indicated by a value of a pre-translation language data may be specified. Alternatively, in advance, a speech recognition engine ID of a speech recognition engine 22 having the highest accuracy of recognizing the speech may be specified. The specified speech recognition engine ID may be then set as a speech recognition engine ID associated with the pre-translation language data in the language engine correspondence management data.

For example, the engine determining unit 46 may specify a combination of a value of pre-translation language data and a value of post-translation language data of metadata included in analysis target data received by the speech data receiving unit 20 when the first speaker enters speech. The engine determining unit 46 may then specify a record of language engine correspondence management data having the same combination of a value of pre-translation language data and a value of post-translation language data as the specified combination. The engine determining unit 46 may specify a combination of a speech recognition engine ID, a translation engine ID, and a speech synthesis engine ID included in the specified record of language engine correspondence management data.

The engine determining unit 46 may specify a plurality of records of language engine correspondence management data having the same combination of the value of pre-translation language data and the value of post-translation language data as the specified combination. In this case, for example, the engine determining unit 46 may specify a combination of a speech recognition engine ID, a translation engine ID, and a speech synthesis engine ID that are included in any one of the records of language engine correspondence management data based on a given standard.

The engine determining unit 46 may determine a speech recognition engine 22 that is identified by the speech recognition engine ID included in the specified combination as a first speech recognition engine 22. The engine determining unit 46 may determine a translation engine 28 that is identified by the translation engine ID included in the determined combination as a first translation engine 28. The engine determining unit 46 may determine a speech synthesis engine 34 that is identified by the speech synthesis engine ID included in the determined combination as a first speech synthesis engine 34.

Similarly, when the second speaker enters speech, the engine determining unit 46 may determine a combination of a second speech recognition engine 22, a second translation engine 28, and a second speech synthesis engine 34 based on a combination of a pre-translation language and a post-translation language.

In this way, speech translation can be performed using an appropriate combination of a speech recognition engine 22, a translation engine 28, and a speech synthesis engine 34 in accordance with a combination of a pre-translation language and a post-translation language.

The engine determining unit 46 may determine a first speech recognition engine 22 or a second speech recognition engine 22 based only on a pre-translation language.

Here, the analysis unit 44 may analyze pre-translation speech data included in analysis target data received by the speech data receiving unit 20 so as to specify a language of the speech indicated by the pre-translation speech data. The engine determining unit 46 may then determine at least one of a speech recognition engine 22 and a translation engine 28 based on the language specified by the analysis unit 44.

The engine determining unit 46 may determine at least one of a speech recognition engine 22, a translation engine 28, and a speech synthesis engine 34 based on, for example, a location of a translation terminal 12 when the speech is entered. Here, for example, at least one of a speech recognition engine 22, a translation engine 28, and a speech synthesis engine 34 may be determined based on a country in which the translation terminal 12 is located. For example, when the translation engine 28 determined by the engine determining unit 46 is not usable in the country in which the translation terminal 12 is located, a translation engine 28 that executes the translation processing may be determined from the rest of translation engines 28. In this case, for example, at least one of a speech recognition engine 22, a translation engine 28, and a speech synthesis engine 34 may be determined based on the language engine correspondence management data including country data indicative of the country.

A location of a translation terminal 12 may be specified based on an IP address of a header of the analysis target data sent from the translation terminal 12. For example, if the translation terminal 12 includes a GPS module, the translation terminal 12 may send, to the server 10, analysis target data including data indicating the location of the translation terminal 12, such as the latitude and longitude measured by the GPS module, as metadata. The location of the translation terminal 12 may be then specified based on the data indicating the location included in the metadata.

The engine determining unit 46 may determine a translation engine 28 that executes the translation processing based on, for example, a topic or a scene estimated by the analysis unit 44. Here, the engine determining unit 46 may determine a translation engine 28 that executes the translation processing based on, for example, a value of topic data or a value of scene data included in the terminal log data. In this case, for example, a translation engine 28 that executes the translation processing may be determined based on attribute engine correspondence management data including the topic data indicating topics and the scene data indicating scenes.

For example, when the first speaker enters speech, the engine determining unit 46 may determine a combination of a first translation engine 28 and a first speech synthesis engine 34 based on attributes of the first speaker.

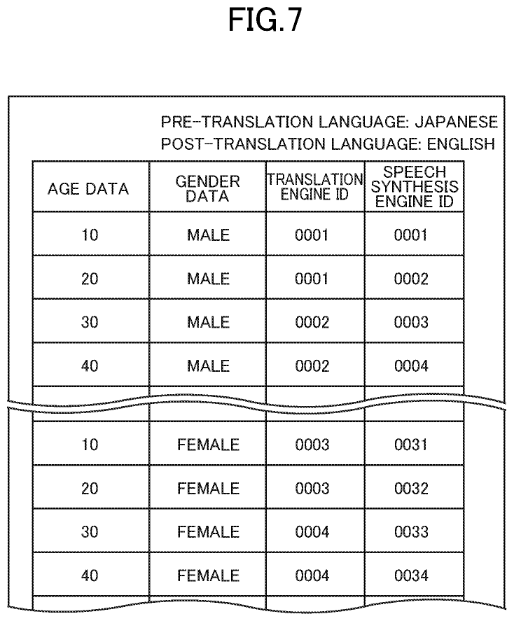

Here, for example, the engine determining unit 46 may determine a combination of a first translation engine 28 and a first speech synthesis engine 34 based on attribute engine correspondence management data illustrated in FIG. 7.

FIG. 7 shows examples of the attribute engine correspondence management data in which a pre-translation language is Japanese and a post-translation language is English. As shown in FIG. 7, the attribute engine correspondence management data includes age data, gender data, a translation engine ID, and a speech synthesis engine ID. A suitable combination of a translation engine 28 and a speech synthesis engine 34 for reproducing attributes of a speaker, such as the speaker's age, generation, and gender may be set in the attribute engine correspondence management data previously. The attribute engine correspondence management data may be stored in the correspondence management data storage unit 48 in advance.

For example, a translation engine 28 capable of reproducing a speaker's attributes, such as age or generation indicated by age data and gender indicated by gender data, may be specified in advance. Alternatively, a translation engine ID of a translation engine 28 having the highest accuracy of reproduction of the speaker's attributes may be specified in advance. The specified translation engine ID may be set as a translation engine ID associated with the age data and the gender data in the attribute engine correspondence management data.

For example, a speech synthesis engine 34 capable of reproducing a speaker's attributes, such as age or generation indicated by age data and gender indicated by gender data, may be specified in advance. Alternatively, a speech synthesis engine ID of a speech synthesis engine 34 having the highest accuracy of reproduction of the speaker's attributes may be specified in advance. The specified speech synthesis engine ID may be set as a speech synthesis engine ID associated with the age data and the gender data in the attribute engine correspondence management data.

For example, assume that, when the first speaker enters speech, the engine determining unit 46 specifies that Japanese is a pre-translation language and English is a post-translation language. Further, assume that the engine determining unit 46 specifies a combination of a value indicating the speaker's age or generation and a value indicating the speaker's gender based on an analysis result of the analysis unit 44. In this case, the engine determining unit 46 may specify, in the records of the attribute engine correspondence management data shown in FIG. 7, a record having the same combination of values of age data and gender data as the specified combination. The engine determining unit 46 may specify a combination of a translation engine ID and a speech synthesis engine ID included in the specified record of the attribute engine correspondence management data.

In the records of the attribute engine correspondence management data shown in FIG. 7, the engine determining unit 46 may specify a plurality of records having the same combination of values of age data and gender data as the specified combination. In this case, the engine determining unit 46 may specify a combination of a translation engine ID and a speech synthesis engine ID included in anyone of the records of the attribute engine correspondence management data based on a given standard, for example.

The engine determining unit 46 may determine a translation engine 28, which is identified by the translation engine ID included in the specified combination, as a first translation engine 28. Further, the engine determining unit 46 may determine a speech synthesis engine 34, which is identified by the speech synthesis engine ID included in the specified combination, as a first speech synthesis engine 34.

The engine determining unit 46 may specify a plurality of combinations of a speech recognition engine ID, a translation engine ID, and a speech synthesis engine ID based on the language engine correspondence management data shown in FIG. 6. In this case, the engine determining unit 46 may narrow down the specified combinations to one combination based on the attribute engine correspondence management data shown in FIG. 7.

In the examples above, the determination is made based on the combination of the first speaker's age or generation and the speaker's gender, although the combination of a first translation engine 28 and a first speech synthesis engine 34 may be determined based on other attributes of the first speaker. For example, a value of emotion data indicating the speaker's emotion may be included in the attribute engine correspondence management data. The engine determining unit 46 may determine a combination of a first translation engine 28 and a first speech synthesis engine 34 based on, for example, the speaker's emotion estimated by the analysis unit 44 and the attribute engine correspondence management data including the emotion data.

Similarly, when the second speaker enters speech, the engine determining unit 46 may determine a combination of a second translation engine 28 and a second speech synthesis engine 34 based on attributes of the second speaker.

As described, the speech corresponding to the first speaker's gender and age is output to the second speaker. Further, the speech corresponding to the second speaker's gender and age is output to the first speaker. In this way, speech translation can be performed with an appropriate combination of a translation engine 28 and a speech synthesis engine 34 in accordance with attributes of a speaker, such as the speaker's age or generation, gender, and emotion.

The engine determining unit 46 may determine one of a first translation engine 28 and a first speech synthesis engine 34 based on the first speaker's attributes. The engine determining unit 46 may determine one of a second translation engine 28 and a second speech synthesis engine 34 based on the second speaker's attributes.

The engine determining unit 46 may determine a combination of a speech recognition engine 22, a translation engine 28, and a speech synthesis engine 34 based on terminal log data stored in the log data storage unit 42.

For example, when the first speaker enters speech, the engine determining unit 46 may estimate the first speaker's attributes, such as age, generation, gender, and emotion, based on age data, gender data, and emotion data of the terminal log data in which a value of the speaker ID is 1. Based on results of the estimation, a combination of a first translation engine 28 and a first speech synthesis engine 34 may be determined. In this case, the first speaker's attributes, such as age or generation, gender, and emotion, may be estimated based on a predetermined number of records of the terminal log data in order from the record having the latest time data. In this case, the speech in accordance with the first speaker's gender and age is output to the second speaker.

When the second speaker enters speech, the engine determining unit 46 may estimate the first speaker's attributes, such as age or generation, gender, and emotion, based on age data, gender data, and emotion data of the terminal log data in which a value of speaker ID is 1. The engine determining unit 46 may determine a combination of a second translation engine 28 and a second speech synthesis engine 34 based on results of the estimation. In this case, in response to the entry of speech by the second speaker, the speech synthesizing unit 36 synthesizes speech in accordance with the first speaker's attributes, such as age or generation, gender, and emotion. In this case, the second speaker's attributes, such as gender and age, may be estimated based on a predetermined number of records of the terminal log data in order from the record having the latest time data.

In this way, in response to the speech entry operation of the second speaker, the speech in accordance with the attributes such as age or generation, gender, emotion of the first speaker, who is the conversation partner of the second speaker, is output to the first speaker.

For example, assume that a first speaker is a female child who speaks English, and a second speaker is an adult male who speaks Japanese. In this case, it may be desirable for the first speaker if the speech in voice type and tone of a female child instead of an adult male is output to the first speaker. For example, in this case, it may be desirable if the speech, in which a text including relatively simple words that female children are likely to know is synthesized, is output to the first speaker. For example, in the above described case, it may be more effective to output the speech in accordance with attributes of the first speaker, such as age or generation, gender, and emotion, to the first speaker in response to the speech entry operation of the second speaker.

The engine determining unit 46 may determine a combination of a speech recognition engine 22, a translation engine 28, and a speech synthesis engine 34 based on a combination of analysis results of the terminal log data and the analysis unit 44.

When the first speaker enters speech, the engine determining unit 46 may determine at least one of a first translation engine 28 and a first speech synthesis engine 34 based on the first speaker's speech entry speed. When the first speaker enters speech, the engine determining unit 46 may determine at least one of a first translation engine 28 and a first speech synthesis engine 34 based on volume of the first speaker's speech. When the first speaker enters speech, the engine determining unit 46 may determine at least one of a first translation engine 28 and a first speech synthesis engine 34 based on voice type or tone of the first speaker's speech. In this regard, entry speed, volume, voice type, and tone of the first speaker's speech may be determined based on, for example, analysis results of the analysis unit 44 or terminal log data having 1 as a value of a speaker ID.

When the first speaker enters speech, the speech synthesizing unit 36 may synthesize speech at speed in accordance with the entry speed of the speech of the first speaker. For example, the speech synthesizing unit 36 may synthesize speech that is output by taking a period of time equal to or multiple times of the speech entry time of the first speaker. In this way, the speech at speed in accordance with the entry speed of the speech of the first speaker is output to the second speaker.

When the first speaker enters speech, the speech synthesizing unit 36 may synthesize speech at volume in accordance with the volume of the speech of the first speaker. For example, speech at the same or a predetermined times of volume of the speech of the first speaker may be synthesized. This enables to output speech at volume in accordance with the volume of the speech of the first speaker to the second speaker.

When the first speaker enters speech, the speech synthesizing unit 36 may synthesize speech having voice type or tone in accordance with voice type or tone of the speech of the first speaker. Here, for example, speech having the same voice type or tone as the speech of the first speaker may be synthesized. For example, speech having the same spectrum as the speech of the first speaker may be synthesized. In this way, speech having voice type or tone in accordance with voice type or tone of the speech of the first speaker is output to the second speaker.

When the second speaker enters speech, the engine determining unit 46 may determine at least one of a second translation engine 28 and a second speech synthesis engine 34 based on entry speed of the speech by the first speaker. When the second speaker enters speech, the engine determining unit 46 may determine at least one of a second translation engine 28 and a second speech synthesis engine 34 based on the volume of the speech of the first speaker. Here, the entry speed or the volume of the first speaker's speech may be determined based on, for example, terminal log data having 1 as a value of a speaker ID.

When the second speaker enters speech, the speech synthesizing unit 36 may synthesize speech at volume in accordance with the entry speed of the speech of the first speaker. In this regard, for example, the speech synthesizing unit 36 may synthesize speech that is output by taking a period of time equal to or multiple times of the speech entry time of the first speaker. In this way, in response to the speech entry operation of the second speaker, speech at speed in accordance with the entry speed of the speech of the first speaker who is the conversation partner of the second speaker is output to the first speaker, regardless of the entry speed of the second speaker's speech. In other words, the first speaker is able to hear speech at speed in accordance with the speed of the first speaker's own speech.

When the second speaker enters speech, the speech synthesizing unit 36 may synthesize speech at volume in accordance with the volume of the speech of the first speaker. Here, for example, speech at the same or a predetermined times of volume of the speech of the first speaker may be synthesized.

In this way, in response to the speech entry operation of the second speaker, speech at volume in accordance with the volume of the speech of the first speaker who is the conversation partner of the second speaker is output to the first speaker, regardless of the volume of the second speaker's speech. In other words, the first speaker can hear speech at volume in accordance with the volume of the first speaker's own speech.

When the second speaker enters speech, the speech synthesizing unit 36 may synthesize speech having voice type or tone in accordance with the voice type or tone of the speech of the first speaker. Here, for example, speech having the same voice type or tone as the speech of the first speaker may be synthesized. For example, speech having the same spectrum as the speech of the first speaker may be synthesized.

In this way, in response to the speech entry operation of the second speaker, speech having voice type or tone in accordance with the voice type or tone of the speech of the first speaker who is the conversation partner of the second speaker is output to the first speaker, regardless of the voice type or tone of the second speaker's speech. In other words, the first speaker is able to hear speech having the voice type or tone in accordance with the voice type or tone of the first speaker's own speech.

In response to the speech entry operation of the second speaker, the translation unit 30 may determine a plurality of translation candidates for a translation target word included in text generated by the speech recognition unit 24. The translation unit 30 may check each of the determined translation candidates to see if there is a word included in a text generated in response to the speech entry operation of the first speaker. Here, for example, the translation unit 30 may check each of the determined translation candidates to see if there is a word included in text indicated by the pre-translation text data or the translated text data in the terminal log data having 1 as a value of a speaker ID. The translation unit 30 may translate the translation target word into a word that is determined to be included in the text generated in response to the speech entry operation of the first speaker.

In this way, a word vocally entered in the recent conversation by the first speaker who is the conversation partner of the second speaker is vocally output, and thus the conversation can proceed smoothly without unnaturalness.

The translation unit 30 may determine whether the translation processing is performed with use of a technical term dictionary based on a topic or a scene estimated by the analysis unit 44.

In the above description, the first speech recognition engine 22, the first translation engine 28, the first speech synthesis engine 34, the second speech recognition engine 22, the second translation engine 28, and the second speech synthesis engine 34 do not necessarily correspond to software modules on a one-to-one basis. For example, some of the first speech recognition engine 22, the first translation engine 28, and the first speech synthesis engine 34 may be implemented by a single software module. Further, for example, the first translation engine 28 and the second translation engine 28 may be implemented by a single software module.

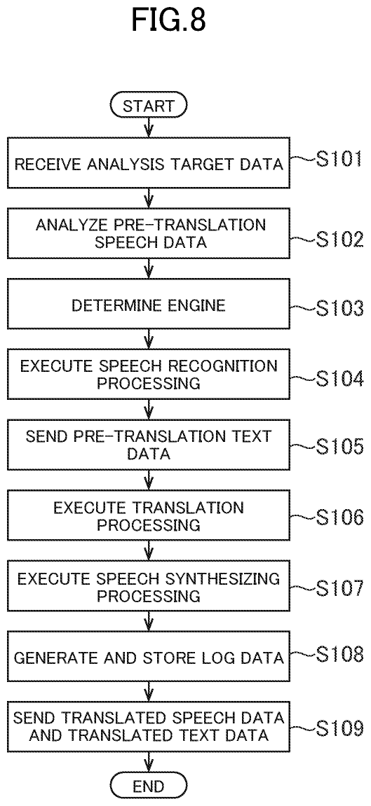

In the following, referring to the flow chart in FIG. 8, an example of processing executed in the server 10 according to this embodiment when the first speaker enters speech will be described.

The speech data receiving unit 20 receives analysis target data from a translation terminal 12 (S101).

Subsequently, the analysis unit 44 executes analysis processing on pre-translation speech data included in the analysis target data received in S101 (S102).

The engine determining unit 46 determines a combination of a first speech recognition engine 22, a first translation engine 28, and a first speech synthesis engine 34 based on, for example, terminal log data or a result of executing the analysis processing as described in S102 (S103).

The speech recognition unit 24 then executes speech recognition processing implemented by the first speech recognition engine 22, which is determined in S103, to generate pre-translation text data indicating text that is a recognition result of speech indicated by the pre-translation speech data included in the analysis target data received in S101 (S104).

The pre-translation text data sending unit 26 sends the pre-translation text data generated in S104 to the translation terminal 12 (S105). The pre-translation text data thus sent is displayed on a display part 12e of the translation terminal 12.

The translation unit 30 executes translation processing implemented by the first translation engine 28 to generate translated text data indicating text obtained by translating the text indicated by the pre-translation text data generated in S104 into the second language (S106).

The speech synthesizing unit 36 executes speech synthesizing processing implemented by the first speech synthesis engine 34, to synthesize speech representing the text indicated by the translated text data generated in S106 (S107).

The log data generating unit 40 then generates log data and stores the generated data in the log data storage unit 42 (S108). Here, for example, the log data may be generated based on the metadata included in the analysis target data received in S101, the analysis result in the processing in S102, the pre-translation text data generated in S104, and the translated text data generated in S106.

The speech data sending unit 38 then sends the translated speech data representing the speech synthesized in S107 to the translation terminal 12, and the translated text data sending unit sends the translated text data generated in S106 to the translation terminal 12 (S109). The translated text data thus sent is displayed on the display part 12e of the translation terminal 12. Further, the speech representing the translated speech data thus sent is vocally output from a speaker 12g of the translation terminal 12. The processing described in this example then terminates.

When the second speaker enters speech, processing similar to the processing indicated in the flow chart in FIG. 8 is also performed in the server 10 according to this embodiment. In this case, however, a combination of a second speech recognition engine 22, a second translation engine 28, and a second speech synthesis engine 34 is determined in the processing in S103. Further, in S104, speech recognition processing implemented by the second speech recognition engine 22 determined in S103 is executed. Further, in S106, translation processing implemented by the second translation engine 28 is executed. Further, in S107, speech synthesizing processing implemented by the second speech synthesis engine 34 is executed.

The present invention is not limited to the above described embodiment.

For example, functions of the server 10 may be implemented by a single server or implemented by multiple servers.

For example, speech recognition engines 22, translation engines 28, and speech synthesis engines 34 may be services provided by an external server other than the server 10. The engine determining unit 46 may determine one or more external servers in which speech recognition engines 22, translation engines 28, and speech synthesis engines 34 are respectively implemented. For example, the speech recognition unit 24 may send a request to an external server determined by the engine determining unit 46 and receive a result of speech recognition processing from the external server. Further, for example, the translation unit 30 may send a request to an external server determined by the engine determining unit 46, and receive a result of translation processing from the external server. Further, for example, the speech synthesizing unit 36 may send a request to an external server determined by the engine determining unit 46 and receive a result of the speech synthesizing processing from the external server. Here, for example, the server 10 may call an API of the service described above.

For example, the engine determining unit 46 does not need to determine a combination of a speech recognition engine 22, a translation engine 28, and a speech synthesis engine 34 based on tables as shown in FIGS. 6 and 7. For example, the engine determining unit 46 may determine a combination of a speech recognition engine 22, a translation engine 28, and a speech synthesis engine 34 using a learned machine learning model.

It should be noted that the specific character strings and numerical values described above and the specific character strings and numerical values illustrated in the accompanying drawings are merely examples, and the present invention is not limited to these character strings or numerical values.

The invention claimed is:

1. A bidirectional speech translation system comprising:
a first determining unit that determines a combination of a first speech recognition engine, a first translation engine, and a first speech synthesis engine, based on at least one of a first language, a first language speech entered by a first speaker, a second language, and a second language speech entered by the second speaker;
a first speech recognition unit that executes speech recognition processing implemented by the first speech recognition engine, in response to an entry of the first language speech by the first speaker, to generate text that is a recognition result of the first language speech;
a first translation unit that executes translation processing implemented by the first translation engine to generate text by translating the text generated by the first speech recognition unit into the second language;
a first speech synthesizing unit that executes speech synthesizing processing implemented by the first speech synthesis engine to synthesize speech representing the text translated by the first translation unit;
a second determining unit that determines a combination of a second speech recognition engine, a second translation engine, and a second speech synthesis engine based on at least one of the first language, the first language speech entered by the first speaker, the second language, and the second language speech entered by the second speaker;
a second speech recognition unit that executes speech recognition processing implemented by the second speech recognition engine, in response to an entry of the second language speech by the second speaker, to generate text that is a recognition result of the second language speech;
a second translation unit that executes translation processing implemented by the second translation engine to generate text by translating the text generated by the second speech recognition unit into the first language; and
a second speech synthesizing unit that executes speech synthesizing processing implemented by the second speech synthesis engine to synthesize speech representing the text translated by the second translation unit.

2. The bidirectional speech translation system according to claim 1, wherein
the first speech synthesizing unit synthesizes speech in accordance with at least one of age, generation, and gender of the first speaker estimated based on a feature amount of speech entered by the first speaker.

3. The bidirectional speech translation system according to claim 1, wherein
the first speech synthesizing unit synthesizes speech in accordance with a value indicating emotion of the first speaker estimated based on a feature amount of speech entered by the first speaker.

4. The bidirectional speech translation system according to claim 1, wherein
the second speech synthesizing unit synthesizes speech in accordance with at least one of age, generation, and gender of the first speaker estimated based on a feature amount of speech entered by the first speaker.

5. The bidirectional speech translation system according to claim 1, wherein
the second translation unit:
determines a plurality of translation candidates for a translation target word included in the text generated by the second speech recognition unit,
checks the plurality of translation candidates to see whether each of the translation candidates is included in the text generated by the first translation unit, and
translates the translation target word into a word that is determined to be included in the text generated by the first translation unit.

6. The bidirectional speech translation system according to claim 1, wherein
the first speech synthesizing unit synthesizes speech having a speed in accordance with an entry speed of the first language speech by the first speaker or speech having volume in accordance with volume of the first language speech by the first speaker.

7. The bidirectional speech translation system according to claim 1, wherein
the second speech synthesizing unit synthesizes speech having a speed in accordance with an entry speed of the first language speech by the first speaker or speech having volume in accordance with volume of the first language speech by the first speaker.

8. The bidirectional speech translation system according to claim 1, comprising a terminal that receives an entry of first language speech by the first speaker, outputs speech obtained by translating the first language speech into the second language, receives an entry of second language speech by the second speaker, and outputs speech obtained by translating the second language speech into the first language, wherein
the first determining unit determines the combination of the first speech recognition engine, the first translation engine, and the first speech synthesis engine based on a location of the terminal, and
the second determining unit determines the combination of the second speech recognition engine, the second translation engine, and the second speech synthesis engine based on a location the terminal.

9. A bidirectional speech translation method comprising:
a first determining step of determining a combination of a first speech recognition engine, a first translation engine, and a first speech synthesis engine, based on at least one of a first language, a first language speech entered by a first speaker, a second language, and a second language speech entered by a second speaker;
a first speech recognition step of executing speech recognition processing implemented by the first speech recognition engine, in response to an entry of the first language speech by the first speaker, to generate text that is a recognition result of the first language speech;
a first translation step of executing translation processing implemented by the first translation engine to generate text by translating the text generated in the first speech recognition step into the second language;
a first speech synthesizing step of executing speech synthesizing processing implemented by the first speech synthesis engine to synthesize speech representing the text translated in the first translation step;
a second determining step of determining a combination of a second speech recognition engine, a second translation engine, and a second speech synthesis engine based on at least one of the first language, the first language speech entered by the first speaker, the second language, and the second language speech entered by the second speaker;
a second speech recognition step of executing speech recognition processing implemented by the second speech recognition engine, in response to an entry of the second language speech by the second speaker, to generate text that is a recognition result of the second language speech;
a second translation step of executing translation processing implemented by the second translation engine to generate text by translating the text generated in the second speech recognition step into the first language; and
a second speech synthesizing step of executing speech synthesizing processing implemented by the second speech synthesis engine to synthesize speech representing the text translated in the second translation step.

10. A non-transitory computer readable medium storing a program for causing a computer to execute:
a first determining process of determining a combination of a first speech recognition engine, a first translation engine, and a first speech synthesis engine, based on at least one of a first language, a first language speech entered by a first speaker, a second language, and a second language speech entered by a second speaker;
a first speech recognition process of executing speech recognition processing implemented by the first speech recognition engine, in response to an entry of first language speech by the first speaker, to generate text that is a recognition result of the first language speech;
a first translation process of executing translation processing implemented by the first translation engine to generate text by translating the text generated in the first speech recognition process into the second language;
a first speech synthesizing process of executing speech synthesizing processing implemented by the first speech synthesis engine to synthesize speech representing the text translated in the first translation process;
a second determining process of determining a combination of a second speech recognition engine, a second translation engine, and a second speech synthesis engine based on at least one of the first language, the first language speech entered by the first speaker, the second language, and the second language speech entered by the second speaker;
a second speech recognition process of executing speech recognition processing implemented by the second speech recognition engine, in response to an entry of the second language speech by the second speaker, to generate text that is a recognition result of the second language speech;
a second translation process of executing translation processing implemented by the second translation engine to generate text by translating the text generated in the second speech recognition process into the first language; and
a second speech synthesizing process of executing speech synthesizing processing implemented by the second speech synthesis engine to synthesize speech representing the text translated in the second translation process.
